(19) United States
(12) Patent Application Publication
(10) Pub. No.: US 2015/0116155 A1
(43) Pub. Date: Apr. 30, 2015

(54) METHODS AND SYSTEMS FOR SELF-ALIGNING HIGH DATA RATE COMMUNICATION NETWORKS

(71) Applicant: THE CHARLES STARK DRAPER LABORATORY, INC., Cambridge, MA (US)

(72) Inventors: Cherif Chibane, Tewksbury, MA (US); Sungyung Lim, Acton, MA (US); Timothy B. Easterly, Action, MA (US); John M. Plump, Arlington, MA (US); William W. McFarland, Watham, MA (US); Leena Singh, Lexington, MA (US)

(21) Appl. No.: 14/523,028

(22) Filed: Oct. 24, 2014

Related U.S. Application Data
(60) Provisional application No. 61/895,440, filed on Oct. 25, 2013.

(51) Int. Cl. H01Q 3/34

(52) U.S. Cl. CPC H01Q 3/34
USPC 342/372

(57) ABSTRACT

A communication system is provided. The communication system includes a directional antenna, an antenna steering system to steer the directional antenna, a memory, and one or more processors coupled to the memory, the directional antenna, and the antenna steering system. The one or more processors are configured to identify a communication target and state information associated with the communication target, instruct the antenna steering system to steer the at least one directional antenna towards the communication target based on the state information, instruct the antenna steering system to perform a received power scan within a scan area to determine a maximum received power direction associated with a signal transmitted from the communication target, and track the maximum received power direction.

### CROSS REFERENCE TO RELATED APPLICATIONS

This application claims priority under 35 U.S.C. §119(e) to co-pending U.S. Provisional Application No. 61/895,440, titled “METHODS AND SYSTEMS FOR SELF-ALIGNING HIGH DATA RATE COMMUNICATION NETWORKS,” filed on Oct. 25, 2013, which is hereby incorporated herein by reference in its entirety.

### FEDERALLY SPONSORED RESEARCH

This invention was made with U.S. government support under Government Contract Number FA8750-12-C-0255 awarded by Department of the Air Force. The U.S. government has certain rights in this invention.

### BACKGROUND

1. Technical Field

Aspects of the present disclosure relate to methods and systems for high data rate communication networks.

2. Discussion

High data rate wireless communication networks are desirable in a variety of circumstances including wireless communication networks comprising any number of mobile systems (e.g., ground vehicles, ships, airborne vehicles). Such high data rate communication networks typically operate at high frequencies in order to support the necessary bandwidth for high data rate communication. Received signal power, however, decreases proportional to the square of the frequency and also proportional to the square of the distance. Therefore, a source antenna must radiate a significant amount of signal power to reliably communicate at high data rates over any substantial range.

### SUMMARY OF INVENTION

High data rate communication is desirable between mobile vehicles, for example, to enable the sharing of data between airborne vehicles (AV) flying within a given proximity. AVs, however, are particularly sensitive to weight, size, and power (SWaP) constraints. These SWaP constraints limit the size and type of communication equipment that can be supported by the AV. In this environment, highly directional antennas require less signal power to be transmitted and subsequently smaller SWaP components can be employed. A narrower beam width (i.e., concentrating the signal power emitted) may require antenna alignment to create and sustain communication links within the network. Accordingly, systems and methods for a self aligning high data rate communication network are provided. Various aspects of a self aligning high data rate communication network as disclosed herein enable one or more high data rate communication links to be established between a plurality of mobile systems employing one or more directional antennas.

According to one aspect, a communication system is provided. The communication system includes at least one directional antenna, an antenna steering system to steer the at least one directional antenna, a memory, and one or more processors coupled to the memory, the at least one directional antenna, and the antenna steering system. The one or more processors may be configured to identify a communication target and state information associated with the communication target, instruct the antenna steering system to steer the at least one directional antenna towards the communication target based on the state information, instruct the antenna steering system to perform a received power scan within a scan area via the at least one directional antenna to determine a maximum received power direction associated with a signal transmitted from the communication target, and instruct the antenna steering system to track the maximum received power direction.

In one embodiment, the communication system further comprises at least one omnidirectional antenna. In this embodiment, the one or more processors are configured to identify the communication target and the state information associated with the communication target at least in part by receiving the state information from the communication target via the at least one omnidirectional antenna.

In one embodiment, the state information associated with the communication target includes at least one of a location, a heading, and a speed associated with the communication target.

In one embodiment, the communication system is coupled to a host vehicle and the one or more processors are further configured to compensate a current direction of the at least one directional antenna for attitude changes of the host vehicle. For example, the one or more processors may be further configured to receive vehicle attitude information from at least one of an Attitude and Heading Reference System (AHRS) and an Inertial Navigation System (INS) coupled to the communication system and instruct the antenna steering system to adjust the current direction of the at least one directional antenna based on the received vehicle attitude information.

In one embodiment, the one or more processors are further configured to transmit state information associated with the host vehicle to the communication target. In this embodiment, the communication target may include at least one directional antenna, an antenna steering system to steer the at least one directional antenna, a memory, and one or more processors coupled to the memory, the at least one directional antenna, and the antenna steering system. The one or more processors of the communication target may be configured to receive the state information associated with the communication system and instruct the antenna steering system of the communication target to steer the at least one directional antenna toward the communication system.

In one embodiment, the one or more processors are further configured to perform the received power scan within the scan area by instructing the antenna steering system to steer the at least one directional antenna to form a scan circle, determining a peak power point on the scan circle, and instructing the antenna steering system to steer the at least one directional antenna to form a scan arc with an arc center at the peak power point. For example, the one or more processors may be configured to form the scan circle by steering the directional antenna at a 0.5 degree offset from the scan circle center.

In one embodiment, the one or more processors are configured to instruct the antenna steering system to perform the received power scan within the scan area by instructing the antenna steering system to steer the at least one directional antenna to cover the scan area within a first period of time, instructing the antenna steering system to steer the at least one directional antenna to the maximum received power direction within the scan area, and instructing the antenna steering system to maintain a previous maximum received power direction within the scan area of the at least one directional antenna for a second period of time. For example, the one or more processors may be configured to instruct the antenna steering system to steer the at least one directional antenna to cover the scan area at least in part by instructing the antenna steering system to steer the at least one directional antenna in one of an outward spiral pattern, a circle pattern, an arc pattern, and an ellipse pattern. The communication target may include at least one directional antenna, an antenna steering system to steer the at least one directional antenna, a memory, and one or more processors coupled to the memory, the at least one directional antenna, and the antenna steering system. The one or more processors of the communication target may configured to instruct the antenna steering system to maintain a current direction of the at least one directional antenna of the communication target for the first period of time, instruct the antenna steering system to steer the at least one directional antenna of the communication target to cover the scan area within the second period of time, and instruct the antenna steering system to steer the at least one directional antenna of the communication target to the maximum received power direction within the scan area. The scan area may include, for example, an area between 0 and 5 degrees from a current direction of the at least one directional antenna and the first period may include, for example, a period of time is up to 5 seconds.

In one embodiment, the one or more processors are further configured to instruct the antenna steering system to track the maximum received power direction by instructing the antenna steering system to steer the at least one direction antenna in a fixed radius scan around the maximum received power direction for a first period of time, and instructing the antenna steering system to maintain a current direction of the at least one directional antenna for a second period of time. In this embodiment, the communication target includes at least one directional antenna, a memory, and one or more processors coupled to the memory and the at least one directional antenna. The one or more processors of the communication target may be configured to instruct the antenna steering system of the communication target to maintain a current direction of the at least one directional antenna of the communication target for the first period of time and instruct the antenna steering system of the communication target to perform the fixed radius scan for the second period of time.

According to one aspect, a method of high data rate communication between a communication system and a communication target is provided. The method includes identifying a communication target and state information associated with the communication target, steering at least one directional antenna towards the communication target based on the state information, performing a received power scan within a scan area to determine a maximum received power direction associated with a signal transmitted from the communication target, and tracking the maximum received power direction.

In one embodiment, performing the received power scan within the scan includes steering the at least one directional antenna to form a scan circle, determining a peak power point on the scan circle, and steering the at least one directional antenna to form a scan arc with an arc center at the peak power point.

In one embodiment, performing the received power scan within the scan area includes steering the at least one directional antenna to cover the scan area and steering the at least one directional antenna to the maximum received power direction within the scan area.

In one embodiment, tracking the maximum received power direction includes steering the at least one direction antenna in a fixed radius scan around the maximum received power direction.

According to one aspect, a communication system is provided. The communication system includes at least one directional antenna and an antenna steering system constructed to steer the at least one directional antenna. The antenna steering system includes an elevation motor support structure, an azimuth motor configured to rotate the elevation motor support structure about a first axis, an antenna support structure configured to hold the at least one directional antenna, and an elevation motor configured to rotate the antenna support structure about a second axis, the second axis being perpendicular to the first axis. The communication system may further include one or more processors coupled to a memory, the at least one directional antenna, and the antenna steering system. The one or more processors may be configured to identify a communication target, instruct the antenna steering system to steer the at least one directional antenna towards the communication target, instruct the antenna steering system to perform a received power scan within a scan area to determine a maximum received power direction associated with a signal transmitted from the communication target, and instruct the antenna steering system to track the maximum received power direction.

In one embodiment, the at least one directional antenna includes a feed horn and a lens. In this embodiment, the antenna steering system may further include a beam steering system to steer a radio frequency beam from the feed horn. The beam steering system may include a wedge prism having a vertex angle and being disposed between the feed horn and the lens, the wedge prism being constructed to redirect the radio frequency beam at an offset angle relative to a central axis, the offset angle being positively correlated to the vertex angle of the wedge prism, a wedge prism support structure constructed to support the wedge prism at the distance from the feed horn, and a wedge prism motor constructed to rotate the wedge prism support structure about the central axis.

According to one aspect, a communication system for communication between a plurality of mobile vehicles coupled to a host mobile vehicle among the plurality of mobile vehicles is provided. The communication system comprises at least one directional antenna, a memory, and one or more processors coupled to the memory and the at least one directional antenna and configured to identify a communication target and state information associated with the communication target, steer the at least one directional antenna towards the communication target, perform a received power scan within a scan area via the at least one directional antenna to determine a maximum received power direction, and track the maximum received power direction.

In one embodiment, the communication system further comprises at least one omnidirectional antenna and the one or more processors are configured to identify the communication target and the state information associated with the communication target at least in part by receiving the state information from the communication target via the at least one omnidirectional antenna. In this embodiment, the state information associated with the communication target may include a location, a heading, and a speed associated with the communication target.

In one embodiment, the one or more processors are further configured to compensate a current direction of the at least one directional antenna for attitude changes of the host mobile vehicle. According to this embodiment, the one or more processors may be further configured to receive mobile vehicle attitude information from at least one of an Attitude and Heading Reference System (AHRS) and an Inertial Navigation System (INS) coupled to the communication system. In addition, the one or more processors may be further configured to transform the received host mobile vehicle attitude information into commands to adjust the direction of the at least one directional antenna. In one embodiment, the scan area includes an area between 0 and 5 degrees from the current direction of the at least one of the at least one directional antenna.

In one embodiment, the one or more processors are configured to transmit state information associated with the communication system to the communication target, wherein the communication target includes at least one directional antenna, a memory, and one or more processors coupled to the memory and the at least one directional antenna. The one or more processors of the communication target may be configured to receive the state information associated with the communication system and steer the at least one directional antenna toward the communication system.

In one embodiment, the one or more processors are configured to perform the received power scan within the scan area at least in part by determining the residual error between a current direction of the at least one directional antenna and the received maximum power direction. In this embodiment, the one or more processors may be further configured to perform the received power scan within the scan area in response to a determination that the residual error is below a threshold value by steering the at least one directional antenna to form a scan circle, determining a peak power point on the scan circle, and steering the at least one directional antenna to form a scan arc with an arc center at the peak power point. In addition, the one or more processors may be further configured to perform the received power scan within the scan area in response to a determination that the residual error is above a threshold value by steering the at least one directional antenna to cover the scan area within a first period of time, steering the at least one directional antenna to the maximum received power direction within the scan area, and maintaining a previous maximum received power direction within the scan area of the at least one directional antenna for a second period of time.

According to one embodiment, the one or more processors are configured to perform the received power scan within the scan area by steering the at least one directional antenna to form a scan circle, determining a peak power point on the scan circle, and steering the at least one directional antenna to form a scan arc with an arc center at the peak power point. In this embodiment, the one or more processors may be further configured to create the scan circle by steering the directional antenna at a 0.5 degree offset from the scan circle center.

According to one embodiment, the one or more processors are configured to perform the received power scan within the scan area by steering the at least one directional antenna to cover the scan area within a first period of time, steering the at least one directional antenna to the maximum received power direction within the scan area, and maintaining a previous maximum received power direction within the scan area of the at least one directional antenna for a second period of time. In this embodiment, the one or more processors may be configured to steer the at least one directional antenna to cover the scan area at least in part by steering the at least one directional antenna in at least one of an outward spiral, an ellipse, an arc, and a circle.

In one embodiment, the communication target includes at least one directional antenna, a memory, and one or more processors coupled to the memory and the at least one directional antenna and configured to maintain a current direction of the at least one directional antenna of the communication target for the first period of time, steer the at least one directional antenna of the communication target to cover the scan area within the second period of time, and steer the at least one directional antenna of the communication target to the maximum received power direction within the scan area. In this embodiment, the scan area may include an area between 0 and 5 degrees from a current direction of the at least one directional antenna. In addition, the first period of time may include a period of time up to 5 seconds.

In one embodiment, the one or more processors are further configured to track the maximum received power direction by performing a fixed radius scan for a first period of time, and maintaining a current direction of the at least one directional antenna for a second period of time. In this embodiment, the communication target may include at least one directional antenna, a memory, and one or more processors coupled to the memory and the at least one directional antenna. The one or more processors of the communication target may be configured to maintain a current direction of the at least one antenna of the communication target for the first period of time and perform the fixed radius scan for the second period of time.

In one embodiment, the first period of time is at least 1 second. In one embodiment, the fixed radius scan includes a fixed radius circle formed by rotating the at least one directional antenna with a 0.25 degree offset angle from a direction.

According to one aspect, a method of high data rate communication between a plurality of communication systems, each of the communication systems being coupled to a mobile vehicle of a plurality of mobile vehicles and including at least one directional antenna, a memory, and one or more processors coupled to the memory and the one or more antennas, is provided. The method comprises identifying a communication target and state information associated with the communication target, steering the at least one directional antenna towards the communication target, performing a received power scan within a scan area via the at least one directional antenna to determine a maximum received power direction, and tracking the maximum received power direction.

In one embodiment, the communication system further comprises at least one omnidirectional antenna and identifying the communication target and the state information associated with the communication target includes receiving state information from the communication target via the at least one omnidirectional antenna. In this embodiment, receiving the state information from the communication target may include receiving a location, a heading, and a speed from the communication target.

In one embodiment, the method further comprises compensating a current direction of the at least one directional antenna for attitude changes of a host mobile vehicle. In this embodiment, the method may further comprise receiving attitude information associated with the host mobile vehicle from at least one of an Attitude and Heading Reference System (AHRS) and an Inertial Navigation System (INS) coupled to the communication system. In addition, compensating the current direction of the at least one directional antenna may include transforming the received host mobile vehicle attitude information into commands to adjust the direction of the at least one directional antenna.

According to one embodiment, performing the received power scan within the scan area includes steering the at least one directional antenna in an outward spiral from 0 degrees to 5 degrees relative to a current direction.

According to one embodiment, performing the received power scan within the scan area via the at least one directional antenna includes determining the residual error between a current direction of the at least one directional antenna and the received maximum power direction. In this embodiment, performing the received power scan within the scan area in response to a determination that the residual error is below a threshold value may include steering the at least one directional antenna to form a scan circle, determining a peak power point on the scan circle, and steering the at least one directional antenna to form a scan arc with an arc center at the peak power point. In this embodiment, performing the received power scan within the scan area in response to a determination that the residual error is above a threshold value may include steering the at least one directional antenna to cover the scan area within a first period of time, steering the at least one directional antenna to the maximum received power direction within the scan area, and maintaining a previous maximum received power direction within the scan area of the at least one directional antenna for a second period of time.

In one embodiment, performing the received power scan within the scan area includes steering the at least one directional antenna to form a scan circle, determining a peak power point on the scan circle, and steering the at least one directional antenna to form a scan arc with an arc center at the peak power point. In this embodiment, the scan circle may be formed by steering the directional antenna at a 0.5 degree offset from the scan circle center.

In one embodiment, performing the received power scan within the scan area includes steering the at least one directional antenna to cover the scan area within a first period of time, steering the at least one directional antenna to the maximum received power direction within the scan area, and maintaining a previous maximum received power direction within the scan area of the at least one directional antenna for a second period of time. In this embodiment, steering the at least one directional antenna within the first period of time may include steering the at least one directional antenna to cover the scan area for up to 5 seconds.

In one embodiment, tracking the maximum received power direction includes performing a fixed radius scan for a first period of time and maintaining a current direction of the at least one antenna of the one or more antennas for a second period of time. In this embodiment, performing the fixed radius scan for the first period of time may include steering the at least one directional antenna in a fixed radius circle formed by rotating the at least one directional antenna at a 0.25 degree offset angle relative to a direction. In addition, performing the fixed radius scan for the first period of time may include performing the fixed radius scan for at least 1 second.

According to one aspect, an antenna steering system for steering at least one antenna system is provided. The antenna steering system comprises an elevation motor support structure, an azimuth motor configured to rotate the elevation motor support structure about a first axis, an antenna support structure configured to hold the at least one antenna system, and an elevation motor configured to rotate the antenna support structure about a second axis, the second axis being perpendicular to the first axis.

In one embodiment, the azimuth motor is configured to rotate at least between +110 degrees and −110 degrees in an azimuth direction. In one embodiment, the elevation motor is configured to rotate at least between +10 degrees and −110 degrees in an elevation direction. In one embodiment, the antenna steering system further comprises an azimuth encoder and an elevation encoder. In one embodiment, the at least one antenna system includes at least one feed horn and at least one lens.

According to one aspect, an antenna beam steering system for steering a radio frequency beam from a radio frequency source is provided. The antenna beam steering system comprises a wedge prism having a vertex angle and being disposed a first distance from the radio frequency source and configured to redirect radio frequency beam at a first offset angle relative to a central axis, the first offset angle being positively correlated to the vertex angle of the wedge prism, a wedge prism support structure configured to support the wedge prism at the first distance from the radio frequency beam source, and a wedge prism motor configured to rotate the wedge prism support structure about the central axis.

In one embodiment, the beam steering system further includes a lens disposed a second distance from the radio frequency beam source, the second distance being larger than the first distance. In one embodiment, the lens includes a focal point and wherein the focal point of the lens is the radio frequency beam source. In one embodiment, the lens is configured to redirect the radio frequency beam a second offset angle. In one embodiment, the wedge prism is configured to provide a first offset angle of 0.25 degrees.

According to one aspect, a state based adhoc networking system is provided. The system comprises a memory and a processor coupled to the memory. In one embodiment, the processor is configured to identify state information of a plurality of mobile vehicles, compute a current topology based at least in part on the state information of the plurality of mobile vehicles, compute a desired mobile vehicle topology, compute state information associated with each vehicle of the plurality of vehicles in the desired mobile vehicle topology, and instruct the plurality of mobile vehicles to move consistent with the state information of the vehicle in the desired vehicle topology.

In one embodiment, the state information includes a location, a heading, and a speed. In one embodiment, the desired mobile vehicle topology is computed based at least in part on a cost function. In one embodiment, the cost function is based at least in part on a coverage factor, a data rate factor, and a data priority factor.

Still other aspects, embodiments, and advantages of these exemplary aspects and embodiments are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. In the figures, each identical or nearly identical component that is shown in various figures is represented by a like numeral. For purposes of clarity, not every component may be labeled in every figure. In the figures:

FIG. 1 shows an embodiment of a self aligning communication network;

FIG. 2 shows an embodiment of a distributed vehicle management system;

FIGS. 3A-B show an embodiment of an antenna steering system;

FIGS. 4A-B show an embodiment of an antenna beam steering system;

FIG. 5 shows an embodiment of a pointing, acquisition, and tracking process;

FIG. 6 shows an embodiment of a pointing process;

FIGS. 7A-B show an embodiment of an acquisition process;

FIGS. 8A-B show an embodiment of a tracking process;

FIG. 9 shows an embodiment of a pointing process radiation pattern;

FIG. 10 shows an embodiment of an acquisition process radiation pattern;

FIG. 11 shows an embodiment of a tracking process radiation pattern;

FIG. 12 shows an embodiment of a state based adhoc networking process; and

FIG. 13 shows an embodiment of a maximum power point searching scheme.

### DETAILED DESCRIPTION

According to aspects of the present invention, systems and methods are provided for a self aligning high data rate communication network. High data rate communication networks include, for example, communication networks with data rates in excess of several hundred megabits per second (Mbps). High data rate communication networks are particularly desirable in mobile vehicles including, but not limited to, AVs. These AVs may carry multiple sensors and generate a large amount of data. The AVs, however, require their communication system to be comprised of low SWaP components. Accordingly, in one embodiment, a frequency range employed in the communication link includes millimeter wave (mWave) radio frequency (RF) waves to enable SWaP components to be employed and support a high data rate. Corresponding mWave frequencies include frequencies in excess of 30 GHz that sustain a large degree of atmospheric attenuation during transmission. Accordingly, the signal power from the antenna may be concentrated over a small area (e.g., over a narrow beam width) to reduce signal power emitted (e.g., through the use of directional antennas). Narrow beam widths of the directional antennas, however, may need to be aligned within a small margin of error to ensure sufficient signal power is received. Accordingly, some embodiments relate to a collaborative communication network that aligns directional antennas from various AVs participating in a communication link to create and maintain the communication links while the AVs are in flight.

It is to be appreciated that embodiments of the methods and apparatuses discussed herein are not limited in application to the details of construction and the arrangement of components set forth in the following description or shown in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements, and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

### Example Self Aligning High Data Rate Communication Network

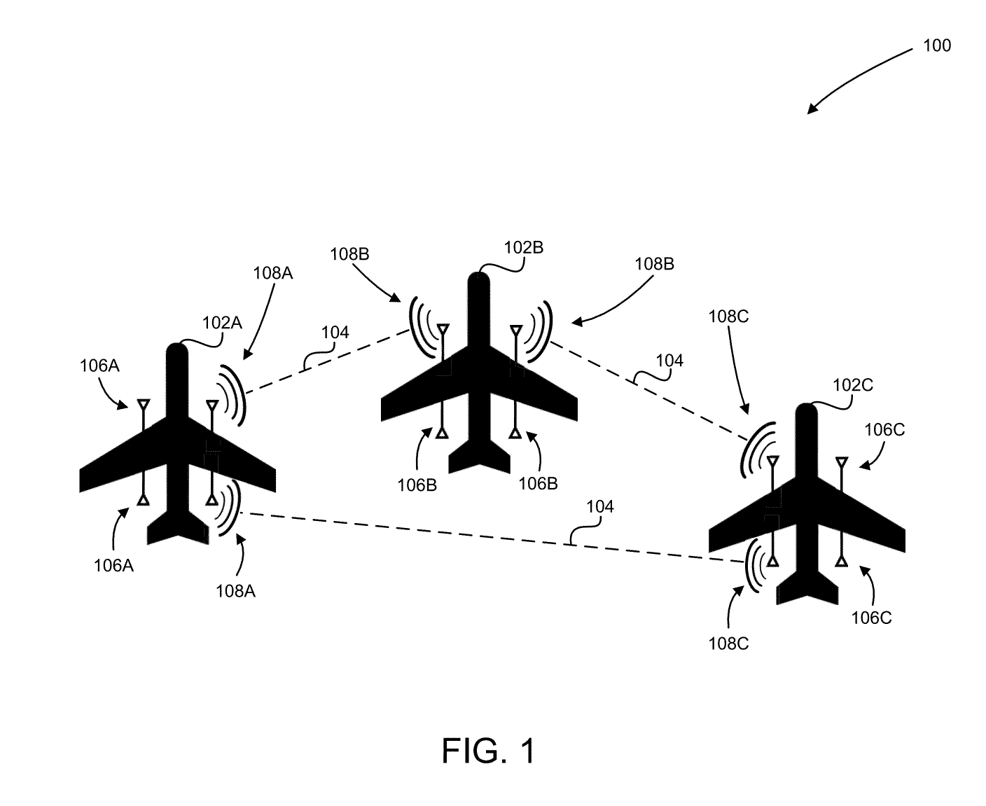

FIG. 1 shows a self aligning high data rate communication network 100 that is configured to create and maintain high data rate communication links between a plurality of communication systems integrated with AVs. It is appreciated that any number and type of AVs may be used in the self aligning high data rate communication network 100. As shown in FIG. 1, the self aligning high data rate communication network 100 includes AVs 102A-C and their respective communication systems comprising non-radiating antennas 106A-C and radiating antennas 108A-C in addition to communication links 104 formed between the radiating antennas 108A-C.

According to one embodiment, the AVs 102A-C are unmanned aerial vehicles (UAV). UAVs are AVs that may operate remotely and/or autonomously. UAVs commonly record and process a large amount of information consistent with reconnaissance roles. The self aligning high data rate communication network 100 embodiments disclosed herein may be employed, for example, with Tier I UAVs (i.e., small UAVs) and Tier II UAVs (short range UAVs).

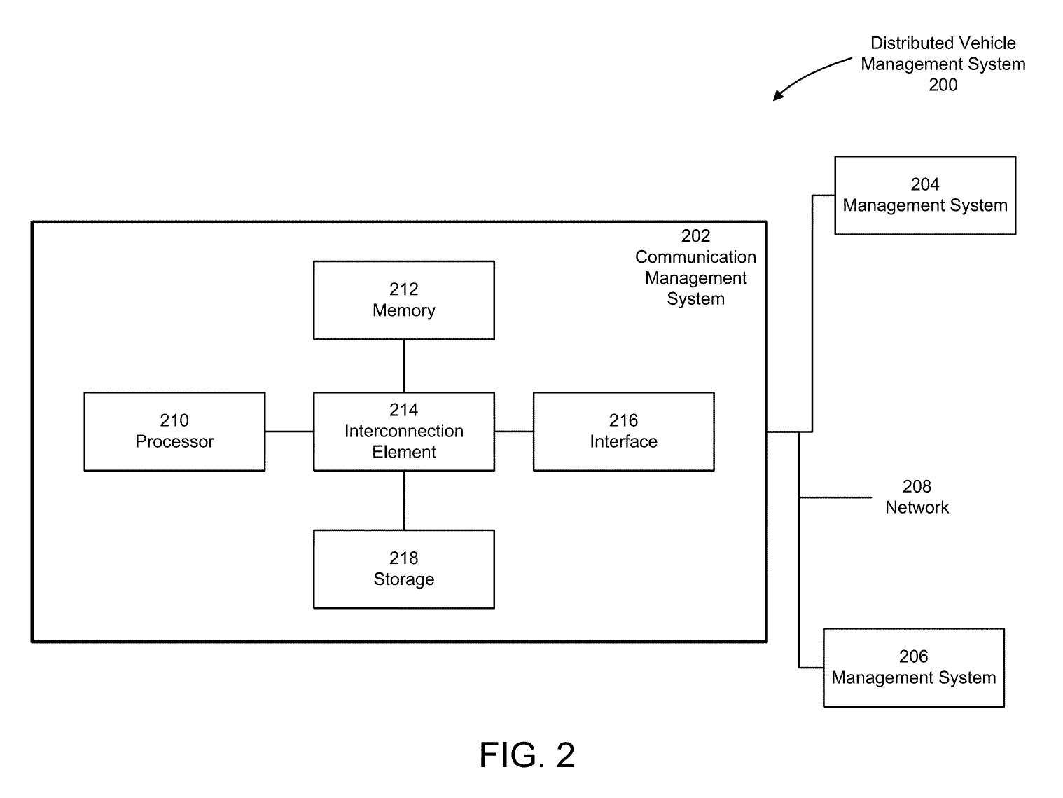

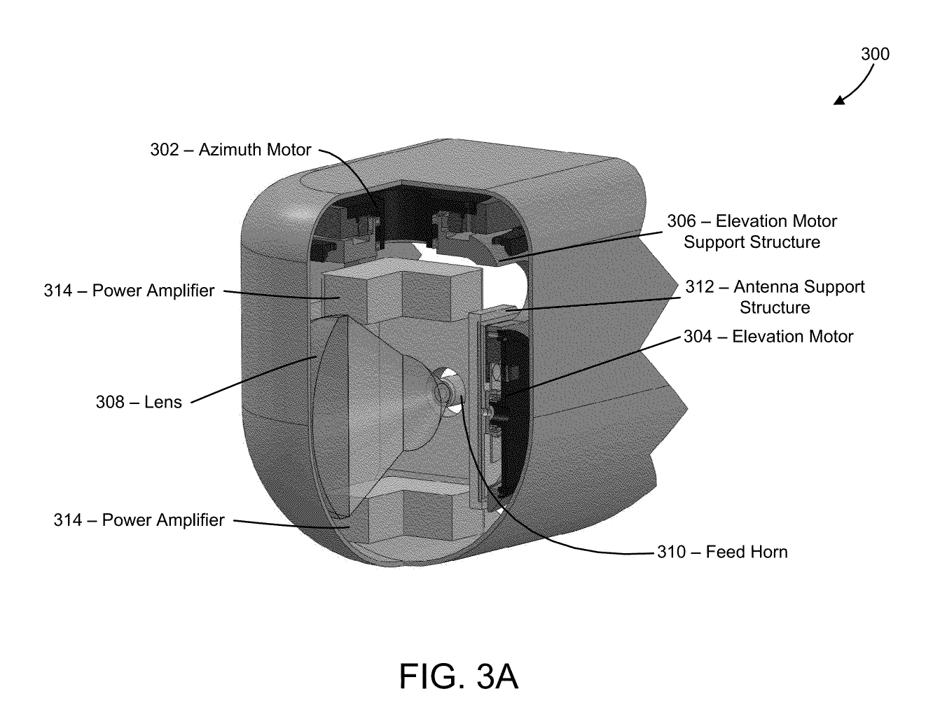

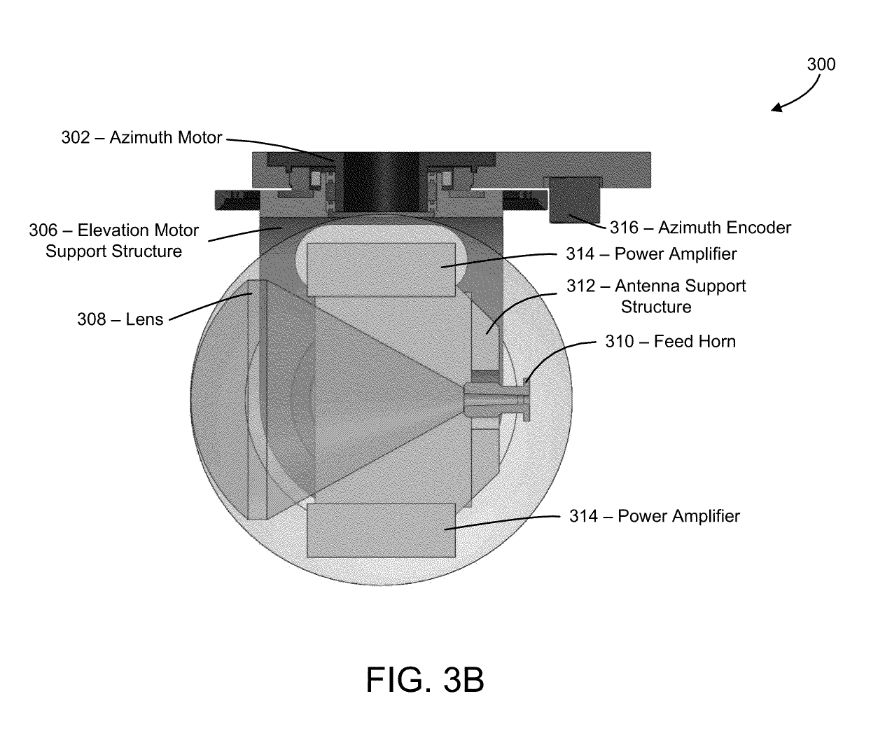

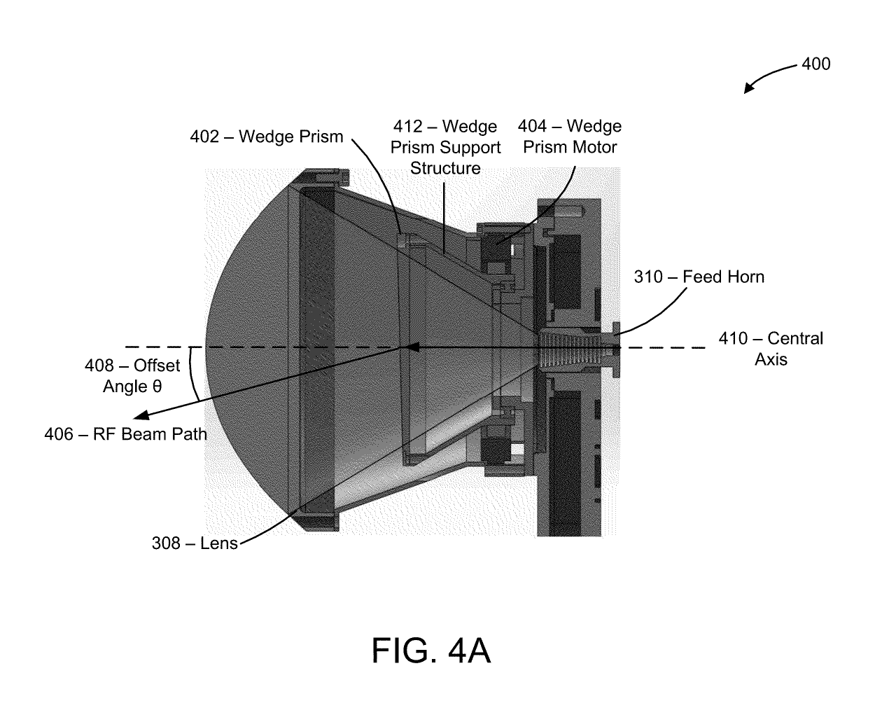

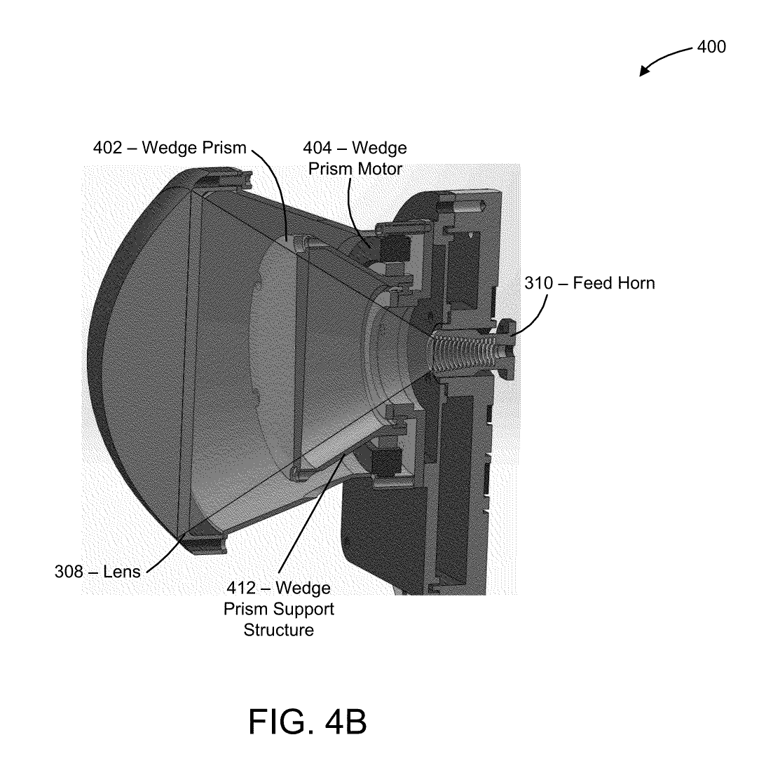

In several embodiments, the communication systems (e.g., antennas 106A-C and 108A-C) of the AVs 102A-C include one or more communication management systems. Various embodiments of communication management systems are described with reference to the communication management systems section and FIG. 2. In one embodiment, the antennas 106A-C and 108A-C are each a pair of antennas comprising a receiving antenna and a transmitting antenna. In this embodiment, the pair of antennas enables full duplex communication via each of the communication links 104. In another embodiment, the antennas 106A-C and 108A-C are each a singular antenna capable of receiving and/or transmitting data. In this embodiment, the antennas 106A-C and 108A-C enable half-duplex communication via each of the communication links 104. It is appreciated that the AVs 102A-C are not limited to having four antennas in total or two radiating antennas 108A-C and two non-radiating antennas 106A-C as shown in FIG. 1. The AVs 102A-C may have any number of antennas and combination of radiating and non-radiating antennas to support the desired number of simultaneous communication links 104. Various embodiments of the antennas 106A-C and 108A-C are described below with reference to FIGS. 3 and 4.

In one embodiment, the communication system further includes at least one antenna steering system adapted to steer the antennas (e.g., antennas 106A-C and 108A-C) and/or the antenna beam steering systems. In one example, the antenna steering system includes a gimbal mechanism that allows the antenna to be steered along at least two perpendicular axes (e.g., a horizontal axis and a vertical axis). Various embodiments of antenna steering systems employed by the communication system are described with reference to the Example Antenna Steering System section below and FIG. 3. It is appreciated that the beam emitted by the antenna may also be steered without necessitating the movement of the entire antenna through one or more antenna beam steering systems. The antenna may comprise, for example, one or more lenses that focus the emitted and/or receive the RF waves. The positioning of the lens within the antenna may enable beam steering. Various embodiments of beam steering systems are described with reference to the Example Antenna Beam Steering System section below and FIG. 4.

In several embodiments, the communication systems include additional antennas to transmit and/or receive state information (e.g., location, heading, and speed) associated with AVs 102A-C to assist the establishment and sustainment of communication links within the network. In some embodiments, the state information transmitted by each communication system is analyzed to identify a location of each AV within a predetermined range. The approximate location may be utilized at least in part to steer the antenna beam towards the location of a communication target (e.g., an AV).

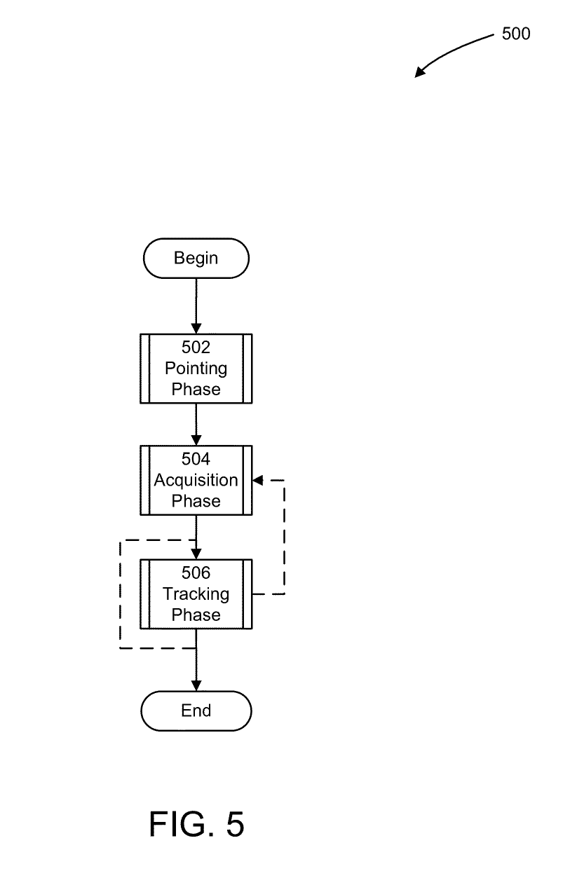

In one embodiment, the communication link 104 comprises overlapping beams from multiple radiating antennas 106A-C that enable full duplex communication. In this embodiment, the communication systems of various AVs participating in the communication link may perform one or more processes to align their respective antennas. In one embodiment, the antennas establish the communication link 104 consistent with a collaborative pointing acquisition and tracking (PAT) process. Various embodiments of the collaborative PAT process are described with reference to the Collaborative Pointing Acquisition and Tracking (PAT) section below and FIGS. 5-11 and 13.

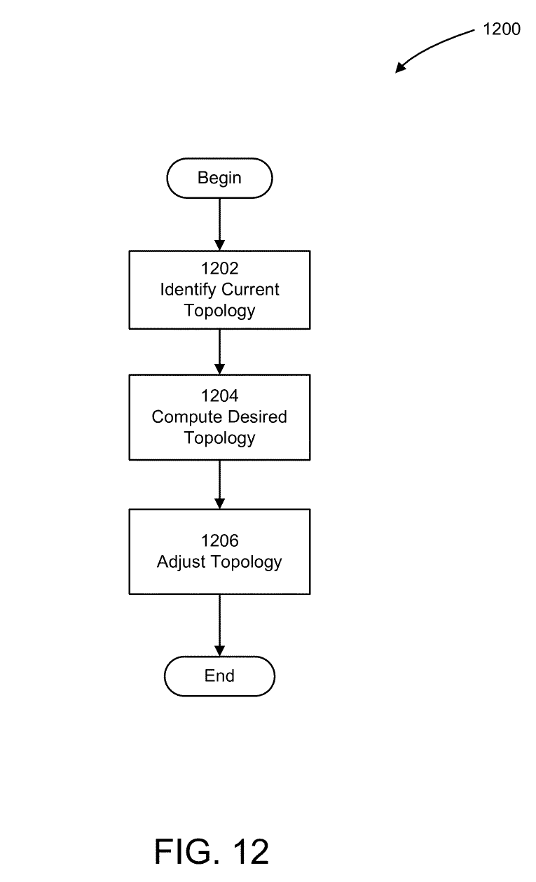

In some embodiments, a plurality of communication links 104 enable an adhoc network to be formed among a plurality of AVs. For example, in one embodiment the communication links 104 may be formed to enable any AV within the formation to communicate with any other AV within the formation. In this embodiment, information may be routed through one or more intermediate AVs prior to reaching its intended destination. In another embodiment, the communication system may interact with other systems (e.g., flight control systems) to modify the flight path of the AV to increase the coverage of the adhoc network in a state-based adhoc network routing scheme. Various embodiments of the adhoc network routing scheme are described with reference the state based adhoc networking section below and FIG. 12.

The various systems and components described herein may be controlled by one or more management systems. The management systems may include, for example, a communication management system.

### Example Communication Management System

Various aspects and functions described herein may be implemented as specialized hardware or software components executing in one or more management systems. Further, aspects may be located on a single management system or may be distributed among a plurality of management systems connected to one or more communication networks. For example, various aspects and functions may be distributed among one or more management systems configured to monitor and/or control a specific vehicle system (e.g., the communication system) as part of a distributed system. Consequently, examples are not limited to executing on any particular system or group of systems. Further, aspects and functions may be implemented in software, hardware or firmware, or any combination thereof. Thus, aspects and functions may be implemented within methods, acts, systems, system elements and components using a variety of hardware and software configurations, and examples are not limited to any particular distributed architecture, network, or communication protocol.

Referring to FIG. 2, a block diagram of a distributed vehicle management system 200 is shown, in which various aspects and functions are practiced. As shown, the distributed vehicle management system 200 includes one more management systems that exchange information. More specifically, the distributed vehicle management system 200 includes communication management systems 202 and management systems 204 and 206 that may perform other tasks relating to monitoring and/or controlling other vehicle systems. As shown, the management systems 202, 204 and 206 are interconnected by, and may exchange data through, a communication network 208. The network 208 may include any communication network through which management systems may exchange data. To exchange data using the network 208, the management systems 202, 204 and 206 and the network 208 may use various methods, protocols and standards, including, among others, Fibre Channel, Token Ring, Ethernet, Wireless Ethernet, Bluetooth, IP, IPV6, TCP/IP, UDP, DTN, HTTP, FTP, SNMP, SMS, MMS, SS7, JSON, SOAP, CORBA, REST and Web Services. To ensure data transfer is secure, the management systems 202, 204 and 206 may transmit data via the network 208 using a variety of security measures including, for example, TLS, SSL or VPN. While the distributed vehicle management system 200 shows three networked management systems, the distributed vehicle management system 200 is not so limited and may include any number and type of management systems, networked using any medium and communication protocol.

Although the communication management system 202 is shown by way of example as one type of communication management system upon which various aspects and functions may be practiced, aspects and functions are not limited to being implemented on the communication management system 202 as shown in FIG. 2. Various aspects and functions may be practiced on one or more communication managements having a different architectures or components than that shown in FIG. 2. For instance, the communication management system 202 may include specially programmed, special-purpose hardware, such as an application-specific integrated circuit (“ASIC”) tailored to perform a particular operation disclosed herein.

As shown in FIG. 2, the communication management system 202 includes a processor 210, a memory 212, an interconnection element 214, an interface 216 and a data storage element 218. To implement at least some of the aspects, functions and processes disclosed herein, the processor 210 performs a series of instructions that result in manipulated data. The processor 210 may be any type of processor, multiprocessor or controller. The processor 210 is connected to other system components, including one or more memory devices 212, by the interconnection element 214.

The memory 212 stores programs and data during operation of the communication management system 202. Thus, the memory 212 may be a relatively high performance, volatile, random access memory such as a dynamic random access memory (“DRAM”) or static memory (“SRAM”). However, the memory 212 may include any device for storing data, such as a disk drive or other non-volatile storage device. Various examples may organize the memory 212 into particularized and, in some cases, unique structures to perform the functions disclosed herein. These data structures may be sized and organized to store values for particular data and types of data.

Components of the communication management system 202 are coupled by an interconnection element such as the interconnection element 214. The interconnection element 214 may include one or more physical busses, for example, busses between components that are integrated within a same machine, but may include any communication coupling between system elements including specialized or standard computing bus technologies such as IDE, SCSI, PCI and InfiniBand. The interconnection element 214 enables communications, such as data and instructions, to be exchanged between system components of the communication management system 202.

The data storage element 218 includes a communication management readable and writeable nonvolatile, or non-transitory, data storage medium in which instructions are stored that define a program or other object that is executed by the processor 210. The data storage element 218 also may include information that is recorded, on or in, the medium, and that is processed by the processor 210 during execution of the program. More specifically, the information may be stored in one or more data structures specifically configured to conserve storage space or increase data exchange performance. The instructions may be persistently stored as encoded signals, and the instructions may cause the processor 210 to perform any of the functions described herein. The medium may, for example, be optical disk, magnetic disk or flash memory, among others. In operation, the processor 210 or some other controller causes data to be read from the nonvolatile recording medium into another memory, such as the memory 212, that allows for faster access to the information by the processor 210 than does the storage medium included in the data storage element 218. The memory may be located in the data storage element 218 or in the memory 212, however, the processor 210 manipulates the data within the memory, and then copies the data to the storage medium associated with the data storage element 218 after processing is completed. A variety of components may manage data movement between the storage medium and other memory elements and examples are not limited to particular data management components. Further, examples are not limited to a particular memory system or data storage system.

The communication management system 202 also includes one or more interfaces 216 through which output devices, input devices, and combination input/output devices can communicate with the communication management system 202. Interface 216 allows the communication management system 202 to exchange information and to communicate with various other communication system components, such as the components under the control of the communication management system. Example components under control of the communication management system include, but are not limited to, antenna steering systems and/or antenna beam steering systems. In some embodiments, the communication management system controls the antenna steering systems and/or antenna beam steering systems to enable the communication system to participate in communication network (e.g., self aligning high data rate communication network 100). In these embodiments, the communication management system may control the steering systems consistent with the pointing acquisition and tracking process described with reference to the Collaborative Pointing Acquisition and Tracking (PAT) section and FIGS. 5-11 and 13.

### Example Antenna Steering System

In some embodiments, communication systems participating in the self aligning high data rate communication network 100 described with reference to FIG. 1 employ one or more directional antennas that concentrate the power emitted and/or received. The directional antennas reduce the amount of signal power transmitted; however, these communication systems may necessitate antenna steering systems to aim the directive antenna towards one or more communication targets.

FIGS. 3A-B show an example of an antenna steering system 300. The antenna steering system 300 may be employed, for example, in the communication systems participating in the self aligning high data rate communication network 100 described with reference to FIG. 1. As shown, the antenna steering system 300 includes an azimuth motor 302, an elevation motor 304, an elevation motor support structure 306, an antenna support structure 312 to steer the antenna system comprising a lens 308, a feed horn 310, and a power amplifier 314.

In some embodiments, the antenna steering system 300 steers an antenna system (e.g., lens 308, feed horn 310, and power amplifier 314) about two axes. Rotation about a first axis (e.g., a vertical axis) is achieved using the azimuth motor 302. The azimuth motor 302 rotates an elevation motor support structure 306 about the first axis. The elevation motor support structure 306 is configured to support the elevation motor 304. The elevation motor 304 rotates the antenna support structure 312 relative to the elevation motor support structure 306 about a second axis (e.g., a horizontal axis). The azimuth motor 302 and the elevation motor 304 are arranged to function similar to a gimbal structure enabling the antenna to be steered along two perpendicular axes independently (i.e., a horizontal axis and a vertical axis). In one embodiment, the azimuth motor 302 is capable of steering the antenna ±110 degrees azimuth and the elevation motor 304 is capable of steering the antenna between the range of +10 degrees and −110 degrees elevation. In another embodiment, the azimuth motor includes an azimuth encoder 316 to measure the azimuth angle of the antenna system. It is appreciated that the elevation motor 304 may also include an elevation encoder to measure the elevation angle of the antenna system.

The antenna support structure 312 supports the antenna system components that enable the transmission and receipt of RF waves. The antenna system may include, for example, a feed horn 310 that converts the communication signals received from the transmitter into RF waves during signal transmission. The feed horn 310 also may receive incoming RF waves and convert the incoming RF waves into an electrical signal to be processed by the receiver and/or transceiver. Power amplifiers 314 may amplify the signal prior to transmission or after receipt to aid in the communication process.

The RF waves emitted and/or received by the transmitted by the feed horn 310 may be directed through one or more reflectors or lenses, such as lens 308. The lens 308 may be supported by the antenna support structure 312 a fixed distance away from the feed horn 310 to arrange the focal point of the lens 308 on the feed horn 310. The construction of the lens 308 changes the propagation pattern of the RF waves. For example, the lens 308 may be constructed to create a beam width of three degrees.

It is appreciated that the azimuth and elevation motors 302 and 304 respectively may have to work harder to achieve displacements that are at the extrema of the operating ranges of the motors. Operating the motors near their relative extrema for long durations of time may reduce the life expectancy of the motor. Accordingly, one or more antenna beam steering systems may be employed in conjunction with the antenna steering system 300 to increase the operating lifespan of the motors.

### Example Antenna Beam Steering System

FIGS. 4A-B show an example of an antenna beam steering system 400. The antenna beam steering system may be employed, for example, in the communication systems participating in the self aligning high data rate communication network 100 described with reference to FIG. 1. As shown, the antenna beam steering system 400 includes a wedge prism 402, a wedge prism support structure 412, and a wedge prism motor 404 that form an RF beam path 406 with a corresponding offset angle 408 relative to a central axis 410 with RF waves emitted and/or received via a lens 308 and a feed horn 310.

In some embodiments, the antenna beam steering system employs a wedge prism 402 situated between the feed horn 310 and the lens 308. The wedge prism 402 changes the RF wave beam path 406 from the feed horn 410. The RF beam leaves the wedge prism 402 at an offset angle 408 relative to the central axis 410. The size of the offset angle is directly correlated to a vertex angle of the wedge prism 402. A larger vertex angle of the wedge prism 402 creates a larger offset angle 408.

The RF beam continues from the wedge prism 402 to the lens 308. The lens 308 focuses the RF beam 406 and may alter the offset angle 408 of the RF beam 406. In one embodiment, the lens 308 is disposed at a distance from the feed horn 310 to align the focal point of the lens with the feed horn 310.

In some embodiments, the wedge prism 402 is connected to a wedge prism motor 404 via a wedge prism support structure 312. The wedge prism motor 404 rotates the wedge prism support structure 412 about the central axis 410. The rotation of the wedge prism support structure 412 rotates the wedge prism 402 and subsequently the RF beam path 406. The RF beam path 406 is directed in a circular motion around the central axis 410 during rotation of the wedge prism 412. It is appreciated that the degree of the vertex angle of the wedge prism 402, and subsequently the offset angle 408, may be altered to suit the specific application. For example, in one embodiment, the antenna beam steering system is adapted to perform a fixed radius scan. The fixed radius scan may be part of an alignment and tracking process such as the Collaborative Pointing Acquisition and Tracking process described below. In this embodiment, the offset angle 408 may be adapted to suit the desired radius of the fixed radius scan.

The antenna steering systems and the antenna beam steering systems described above may be employed to enable highly directive antennas to be employed to establish and maintain communication links. These communication links may include, for example, communication links 104 between communication systems participating in the self aligning high data rate communication network 100 described with reference to FIG. 1. The highly directive antennas, however, may need to be properly aligned in order to create and maintain communication links.

### Collaborative Pointing Acquisition and Tracking (PAT)

FIG. 5 shows an embodiment of a pointing, acquisition, and tracking (PAT) process 500. The PAT process establishes and maintains the communication links between two or more directional antennas. As shown in FIG. 5, the PAT process 500 includes a pointing phase 502, an acquisition phase 504, and a tracking phase 506.

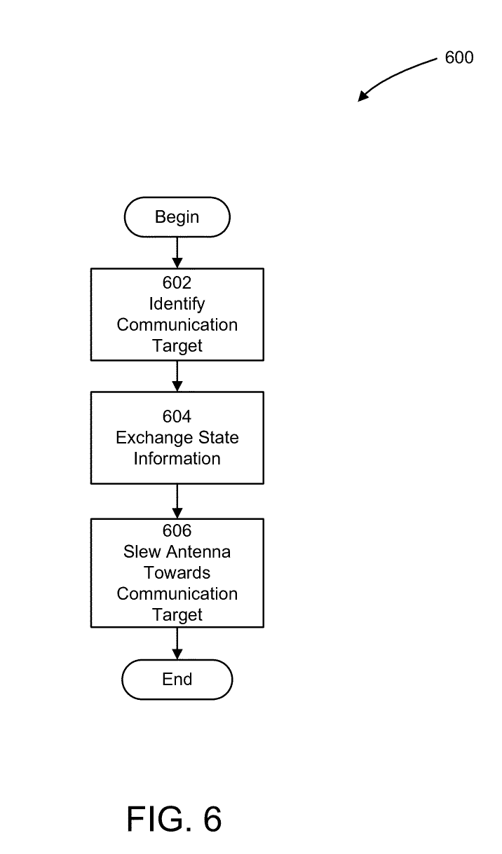

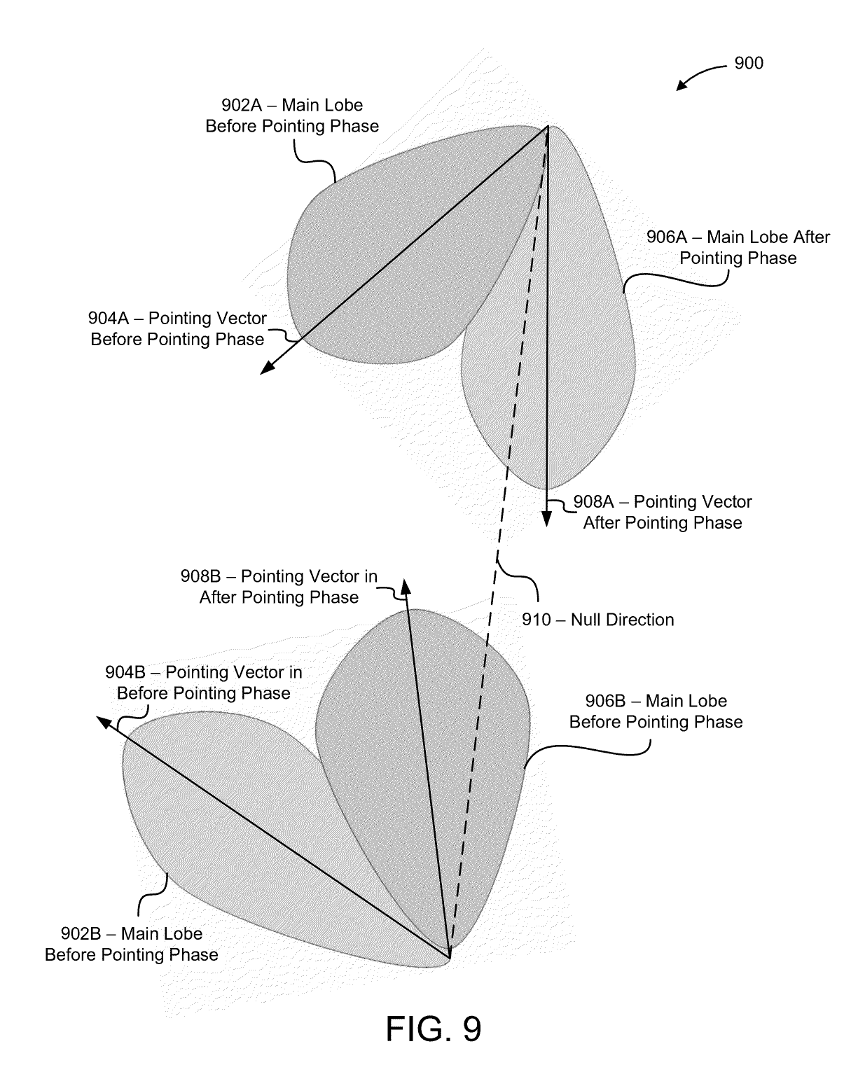

In the pointing phase 502, a first communication system integrated with a first mobile vehicle identifies a communication target (e.g., a second communication system integrated with a second mobile vehicle). The communication target may be identified via one or more discovery radios (e.g., omnidirectional antennas) that detect state information broadcasted by other communication systems associated with other mobile vehicles. The state information broadcast by a communication system may include a location, a heading, and a speed associated with the associated mobile vehicle. Location information may be excluded from the state information to, for example, enhance security. In examples where the location information is excluded, the communication system may determine the current location of the associated mobile vehicle based on, for example, a known starting location of the associated mobile vehicle and information regarding the direction and heading of the associated mobile vehicle. In one embodiment, the received state information is used to steer a directional antenna in the direction of the communication target (e.g., the second mobile vehicle). In this embodiment, the communication target also steers its directional antenna in the direction of the first mobile vehicle. The specific actions in the pointing phase 502 are described in detail in the pointing process 600 with reference to FIG. 6 and the pointing process radiation pattern 900 with reference to FIG. 9. It is appreciated that the received state information may be employed in the acquisition phase 504 and/or the tracking phase 506 to enhance the performance of the communication system.

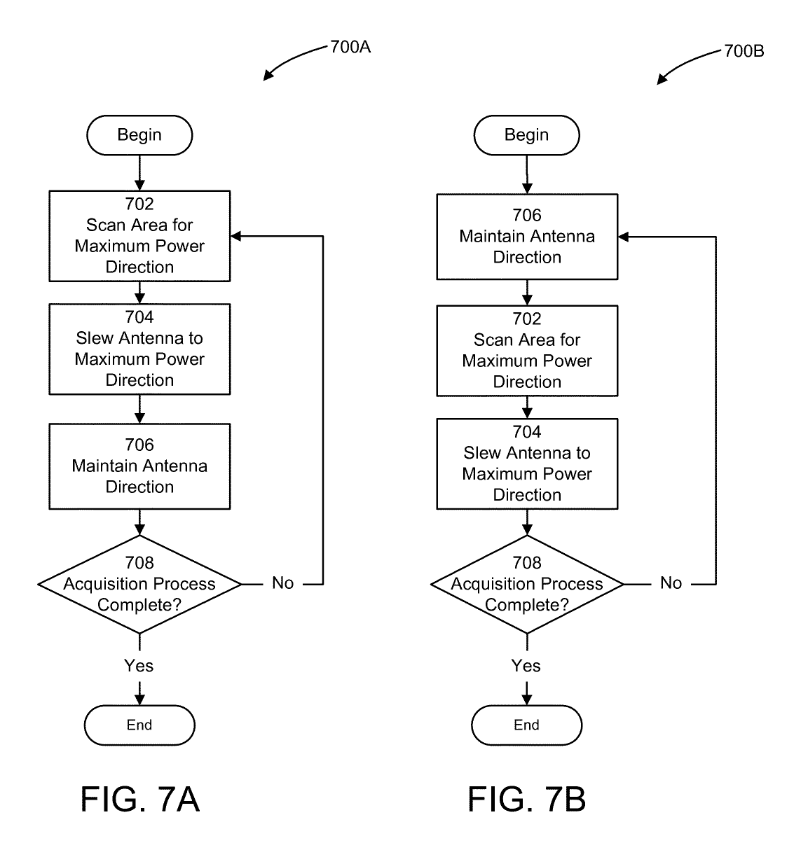

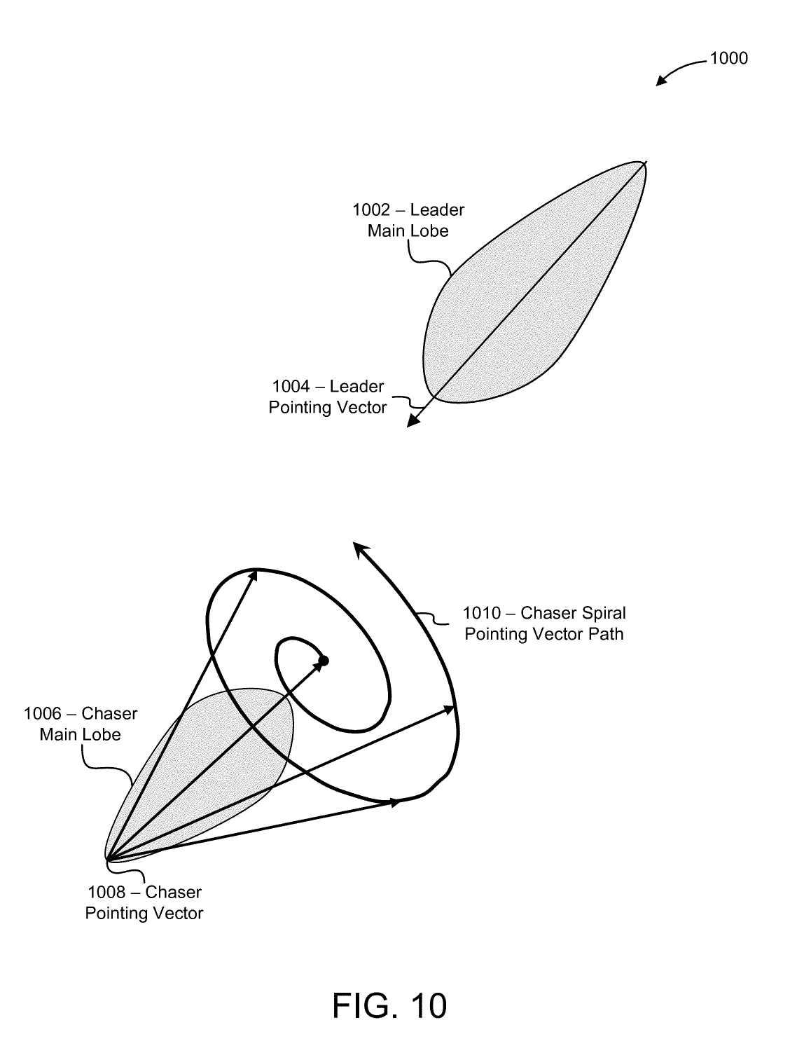

In the acquisition phase 504, each directive antenna finds a power direction that can fall into the main lobe of RF and receive significant RF power above a threshold, close to the maximum power. In one embodiment, the directional antennas of the first and second communication systems perform a collaborative scan process to improve the alignment of the directional antennas. The specific actions in the acquisition phase 504 are described in detail in the acquisition process 700 with reference to FIG. 7 and acquisition process radiation pattern 1000 with reference to FIG. 10.

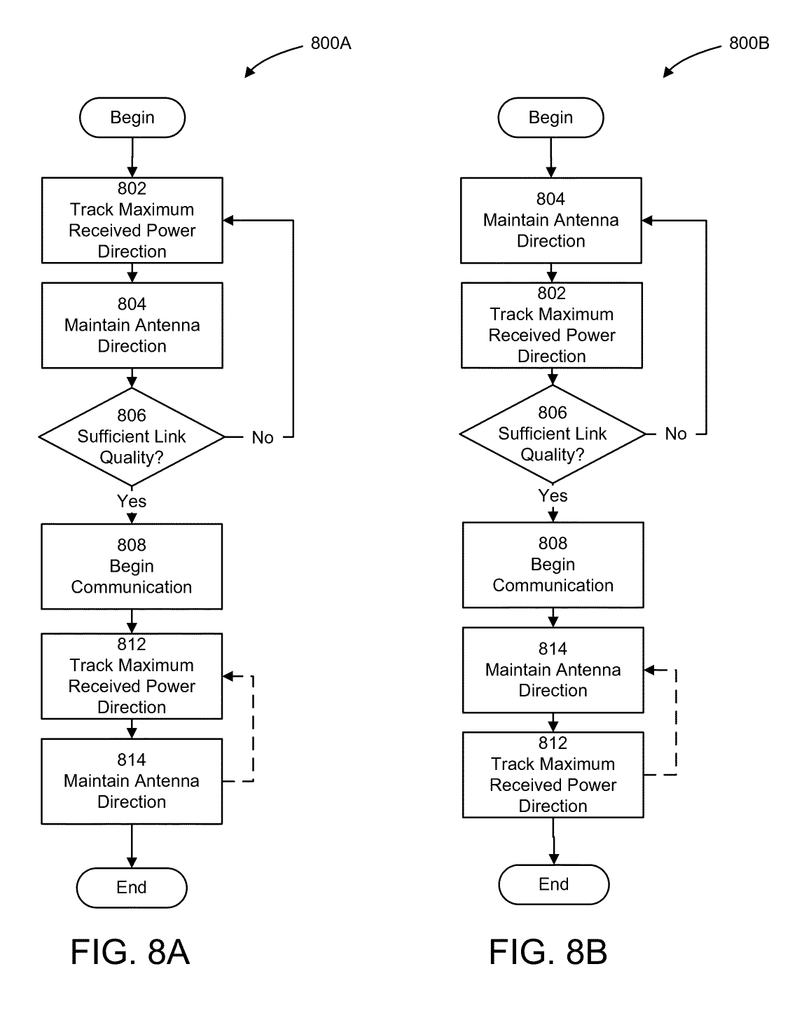

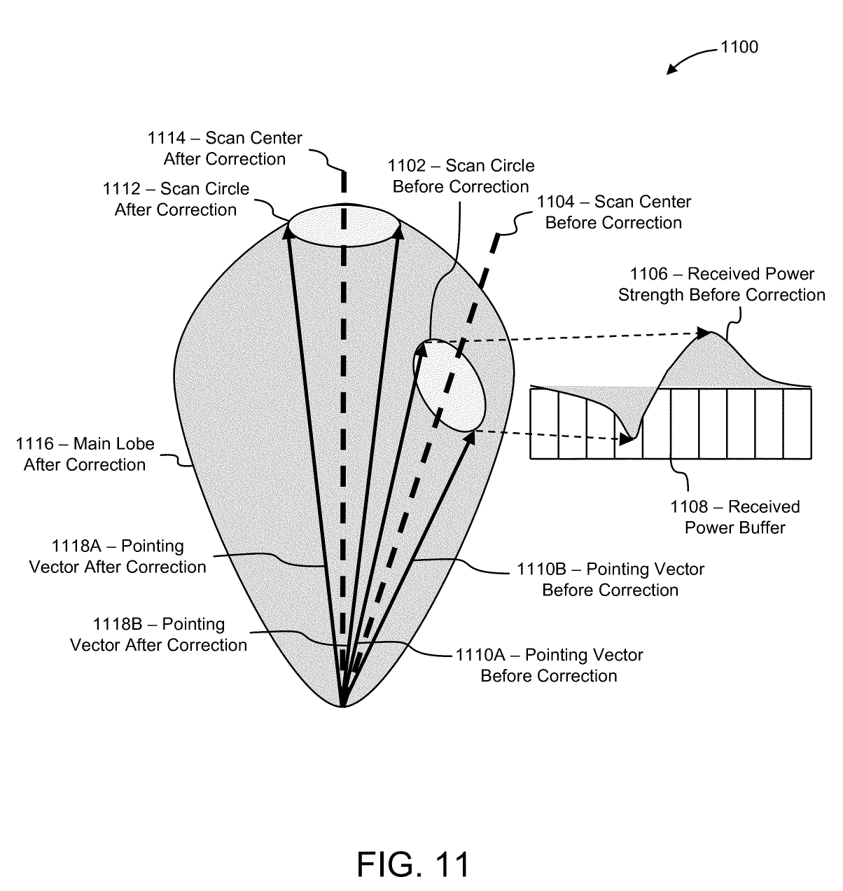

In the tracking phase 506, the directional antennas find the maximum received power direction and are locked onto each other to maintain the power direction. Communication over the high data link is then performed. The tracking phase 506 and/or the acquisition phase 504 may be repeated as necessary to reestablish the communication link if it fails due to a communications anomaly (e.g., a continuous loss of RF signal for certain period of time). The specific actions in the tracking phase 506 are described in detail below in the tracking process 800 with reference to FIG. 8 and tracking process radiation pattern 1100 in with reference to FIG. 11.

In some embodiments, the PAT process described above further includes a transformation of the desired antenna pointing direction to the desired angles of gimbals that steer the directional antenna. In this embodiment, the transformation may be performed with attitude information available from an Attitude and Heading Reference System (AHRS) and/or an Inertial Navigation System (INS). The AHRS and/or INS may employed by, for example, a vehicle management system or a communication system (e.g., communication management system 202). The AHRS and/or INS may provide angular rate measurements to the communication system. These angular rate measurements may be caused by, for example, a planned maneuver of the mobile vehicle and/or low frequency aero-elasticity vibration. The communication system controlling the directional antenna may receive and/or calculate the angular rate measurement and convert the angular rate measurement into feedforward gimbal rate commands to compensate for the attitude change.

In one embodiment, the communication system may bypass the acquisition phase 504 and proceed directly from the pointing phase 502 to the tracking phase 506. The communication system may employ, for example, one or more minimum received power thresholds to make a determination whether to bypass the acquisition phase. It is appreciated that the accuracy of the AHRS and/or INS described above may directly impact the residual pointing error after completion of the pointing phase 502. In particular, the residual pointing error may be primarily determined by the accuracy of the AHRS and/or INS when the operational range between the mobile vehicles is longer than a few kilometers. If the AHRS or INS is very accurate (e.g., 0.05 degrees of attitude knowledge), the residual error is so small that the received power is significant enough to enable the communication system to transition directly to the tracking phase 506 while bypassing the acquisition phase 504. Otherwise, the acquisition phase 504 may be executed to reduce the residual pointing error to the degree that the tracking phase 506 can be executed.

As discussed above with regard to the pointing phase 502 in FIG. 5, various embodiments may implement pointing processes. FIG. 6 shows one such pointing process 600 that includes acts of identifying a communication target 602, exchanging state information with the communication target 604, and slewing the antenna towards the communication target 606.

In the act 602, the communication system detects one or more signals containing state information broadcast by the communication target. In some embodiments, the communication system broadcasts state information associated with the mobile vehicle within which a communication system is integrated. The state information includes, but is not limited to, the location, heading, and speed of the mobile vehicle. In one embodiment, the location of the mobile vehicle is computed via one or more global position systems (GPS). In this embodiment, the heading and speed of the mobile vehicle are gathered via the management systems that govern the movement of the vehicle (e.g., engine management systems). It is appreciated that the state information may be broadcast via one or more antennas. In one example, the state information is broadcast via one or more omnidirectional antennas.

In another embodiment, the state information received in act 602 excludes GPS information to improve the security by increasing the difficulty for hostile systems to determine the exact location of the mobile vehicles. For example, each of the mobile vehicles may receive information regarding a starting location of the other mobile vehicles and/or make an assumption regarding the mobile vehicles (e.g., all of the other UAVs took off from the same airstrip). The mobile vehicles may transmit state information including a current heading and speed associated with the mobile vehicle. The communication system of the receiving mobile vehicle determines the current location of the other mobile vehicles based on the known starting position of the other mobile vehicles and the received information regarding the movements of the other mobile vehicles over time.

In the act 604, the communication system exchanges state information with the communication target. In one embodiment, a direction is computed that points from the communication system to the communication target. In act 606, the communication system slews the directional antenna towards the communication target consistent with the computed direction. It is appreciated that attitude information associated with the host vehicle of the communication system may be employed to determine the desired antenna direction.

It is appreciated that the acts described with reference to pointing process 600 may also be performed by the communication target in a collaborative fashion. In one embodiment, the communication target (e.g., a second mobile vehicle) includes a communication system (e.g., a second communication system) that performs pointing process 600 in sync with the first communication system and subsequently the first mobile vehicle.

An example pointing process radiation pattern 900 is shown with reference FIG. 9 formed by two communication systems executing a pointing process. The pointing process radiation pattern 900 includes a null direction 910 between two radiation patterns formed by a first directional antenna, the first directional antenna radiation pattern comprising a main lobe before pointing phase 902A, a pointing vector before pointing phase 904A, a main lobe after pointing phase 906A, and a pointing vector after pointing phase 908A, and a second directional antenna, the second directional antenna radiation pattern comprising a main lobe before pointing phase 902B, a pointing vector before pointing phase 904B, a main lobe after pointing phase 906B, and a pointing vector after pointing phase 908B.

The pointing vectors of the two directional antennas 904A-B and their corresponding main lobes 902A-B are initially pointing in a random direction relative to their corresponding null direction 910 prior to execution of the pointing process. Execution of the pointing process moves the pointing vectors 908A-B and their corresponding main lobes 906A-B closer to the null direction 910. Although the pointing vectors 908A-B after the pointing process are closer to the null direction 910, the pointing vectors 908A-B may not be sufficiently aligned to establish and maintain a communication link. It is appreciated that the degree of the error between pointing vectors 908A-B and the null direction may be based at least on part on the accuracy of the state information exchanged during the pointing process and the accuracy of attitude knowledge of each communication system as described above. As discussed above with regard to act 504 in FIG. 5, an acquisition phase 504 may follow the pointing phase 502 to improve the alignment of the directional antennas.

In some embodiments, the acquisition processes are collaborative processes between the respective directional antennas of two communication systems (e.g., a first communication system of a first mobile vehicle and a second communication system of a second mobile vehicle). FIGS. 7A-B show an example acquisition process 700A performed by the first communication system and the converse acquisition process 700B performed by the second communication system. Example acquisition processes 700A-B include acts of scanning an area for a maximum power direction 702, and slewing the antenna to the maximum power direction 704, maintaining antenna direction 706, and determining whether the acquisition process is complete 708.

In the act 702 with reference to process 700A, the first communication system steers its directional antenna to scan a predetermined scan area. The received signal power is measured by the directional antenna during the scan to locate a maximum received power direction within the predetermined scan area. In one embodiment, the scan is performed using an outward spiral motion. In this embodiment, the outward spiral continues until the radius of the scan reaches a predetermining maximum angle (e.g., 5 degrees) relative to its position at the start of the spiral scan. It is appreciated that the spiral scan may also be stopped when the received signal power is larger than a predetermined threshold. This outward spiral is particularly effective as an acquisition scan when the residual pointing error at completion of the pointing phase 504 is large (e.g., a couple of degrees).

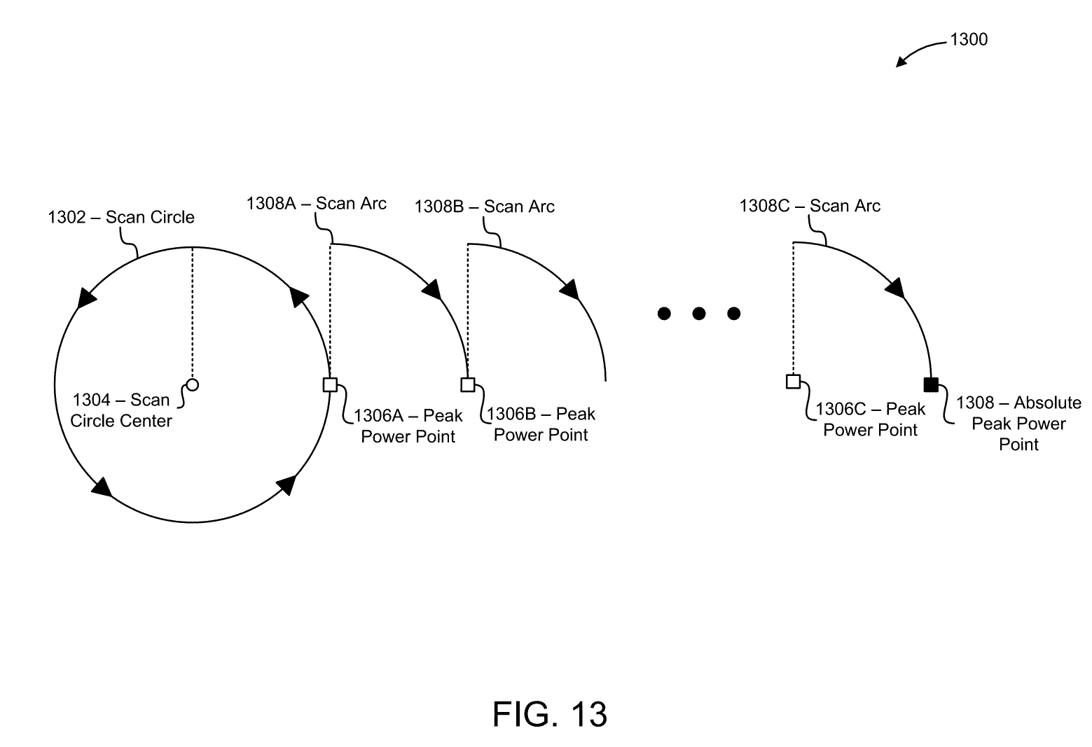

It is appreciated that other maximum power point searching schemes may be employed to find the maximum received power point. Another example maximum power point searching scheme is the arc-type searching scheme. An example arc-type searching scheme is shown in FIG. 13. The arc-type searching scheme 1300 includes a scan circle 1302, a scan center 1304, peak power points 1306A-C, scan arcs 1308A-C, and absolute peak power point 1308.

In one embodiment, communication system steer the directional antenna in a circle around a central point as shown by scan circle 1302 and scan center 1304 respectively. The scan circle 1302 may be formed, for example, by rotating the directional antenna at a 0.5 degree offset from the scan center 1304. The communication system may track the received signal power while steering the directional antenna consistent with the scan circle 1302. The peak power point 1306A on the scan circle 1302 may be located. The scan center 1304 of the scan circle 1302 may be moved to the peak power point 1306. A scan arc 1308A may be performed with the new scan center. The scan arc 1308A may continue until a new peak power point (e.g., peak power point 1306B) is located and/or the received power exceeds a threshold value. The process of performing scan arcs and moving the scan circle center to the new peak power point may continue until an absolute peak power point 1308 is located and/or the received power exceeds a threshold level. It is appreciated that the scan rotational polarity (i.e., clockwise or counter-clockwise polarity) of the scan arc (e.g., scan arc 1308A) may be changed relative to the initial scan circle 1302 depending on the location of the peak power point 1306A on the scan circle 1302.

In one embodiment, the communication system is capable of performing both the outward spiral scan and the arc-type searching schemes. In this embodiment, the communication system makes a determination to use the outward spiral scan or the arc-type searching schemes. The communication system may, for example, make a determination to employ the spiral scan searching scheme in the acquisition phase 504 when the residual error from the pointing phase 502 is above a threshold value (e.g., 2 degrees) and employ the arc-type scan search when the residual error is below the threshold. It is appreciated that the determination to use the outward spiral scan or arc-type searching scheme may be based off of a minimum received signal power threshold.

Once the maximum received power direction has been identified in act 702 of process 700A, the first communication system proceeds to act 704 where the directional antenna is slewed in the direction of the maximum received power. While acts 702 and 704 are being executed by the first communication system in process 700A, the second communication system executes act 706 in process 700B and maintains the direction of the antenna.

The second communication system continues process 700B and performs acts 702 and 704 in a similar fashion to that described with reference to process 700A. While acts 702 and 704 are being executed by the second communication system in process 700B, the first communication system executes act 706 in process 700A and maintains the direction of the antenna. After both the first and second communication systems have completed acts 702, 704, and 706 in processes 700A and 700B respectively, the first and second communication systems determine whether the acquisition process is complete in act 708. An example completion criterion is a predetermined minimum received signal power threshold. The acquisition processes 700A-B may involve one or more additional iterations of processes 700A-B respectively. When one iteration of acquisition process 700A-B is completed without finding the maximum power direction, a new acquisition process 700A-B may be started from a pointing direction offset from the best direction predicted by the shared state information and attitude knowledge as in the pointing process. The offset may be a predetermined parameter (e.g., +5 degrees East). Otherwise, the acquisition process terminates.

It is appreciated that processes 700A and 700B may be assigned arbitrarily to two communication systems establishing a communication link. In addition, processes 700A and 700B may include the assignment of one or more roles to each communication system. In one embodiment, a first communication system is assigned the chaser role and performs acts 702 and 704 while a second communication is assigned the leader role and performs act 706. In this embodiment, the chaser and leader roles are reversed after a period of time. The chaser role, for example, may be first assigned to the northernmost communication system while the leader role may be first assigned to the southernmost communication system.

An example acquisition process radiation pattern 1000 is shown with reference FIG. 10 formed by two communication systems executing an acquisition process. The acquisition process radiation pattern 1000 includes two radiation patterns formed by a leader directional antenna radiation pattern comprising a leader main lobe 1002 and a leader pointing vector 1004 and a chaser directional antenna radiation pattern comprising a chase main lobe 1006, a chaser pointing vector 1008, and a chaser spiral pointing vector path 1010.

In one embodiment, the leader pointing vector 1004 maintains a constant direction. While the leader pointing vector 1004 remains constant, the chaser pointing vector 1008 follows an outward spiral scan shown by the chaser spiral pointing vector path 1010. The chaser pointing vector 1008 is then moved to the maximum received power direction to improve the alignment between the antennas. It is appreciated that the participating communication systems performing the leader and chaser roles respectively may reverse roles and perform one or more iterations of the acquisition process. New acquisition starts from a pointing direction offset from the best direction predicted by the shared state information and attitude knowledge as in the pointing process as described above. As discussed above with regard to act 506 in FIG. 5, a tracking phase 506 may follow the acquisition phase 504 to find and track the maximum power direction to establish and maintain the communication link.

In some embodiments, the tracking process is a collaborative process performed among respective directional antennas of two communication systems (e.g., a first communication system of a first mobile vehicle and a second communication system of a second mobile vehicle). FIGS. 8A-B show an example tracking process 800A performed by the first communication system and the converse tracking process 800B performed by the second communication system. Example tracking processes 800A-B include acts of tracking the maximum received power point for the antenna 802 and 812, maintaining antenna direction 804 and 814, determining whether there is a sufficient link quality 806, and beginning communication 808.

In the act 802 of process 800A, the maximum received power direction is tracked by the first communication system. In some embodiments, the maximum received power direction is tracked by performing a fixed radius scan with the directional antenna. In these embodiments, the center of the scan radius is adjusted to maintain the maximum power received power direction in the center of the scan radius. For example, in one embodiment the fixed radius scan continues for a period of time. In one implementation, the fixed radius of the scan circle may be 0.25 degrees around the previous maximum power received direction and the period of time may be at least 1 second. While the first communication system performs act 802, the second communication maintains the direction of the antenna in act 804. The current direction of the antenna may include a previous maximum power direction.

After the first communication system has completed tracking the maximum received power direction in act 804 of process 800A, the first communication system proceeds to act 804 where the first communication maintains the direction of the antenna. While act 804 is executed by the first communication system in process 800A, the second communication system executes act 802 in process 800B and tracks the maximum received power point in act 804. The maximum received power point is tracked in a similar fashion described with reference to act 804 in process 800A. After both the first and second communication systems have completed the first instance of acts 802 and 804 in processes 800A and 800B respectively, the first and second communication systems determine whether the communication link is of a sufficient quality to begin communication in act 806. For example, the link quality test may include performing one revolution of scanning and determining whether the average RF power over the scan is above a predetermined threshold (e.g., 0.5 db less than the expected maximum RF power). In this example, the first and second communication systems proceed to act 808 and begin communication if the average received power is above the threshold. Otherwise, communication is put on hold and the first and second communication systems repeat acts 802 and 804 as described above.

After communication has begun in act 808, the acts of tracking a maximum received power direction 812 and maintaining an antenna direction 814 are repeated while the communication link remains operational. It is appreciated that the acts of tracking a maximum received power direction 812 and maintaining an antenna direction 814 may have different parameters (e.g., predetermined threshold for the average RF power scan) than the acts of tracking a maximum received power direction 802 and maintaining an antenna direction 804.

The communication link may terminate, for example, based on anomalies (e.g., a continuous loss of RF signal for certain period of time) or a received command to terminate the communication link. In the case of communication link anomalies, the communication systems may repeat the tracking and/or acquisition processes to re-establish the communication link. For example, in one implementation, a RF signal loss for more than 0.4 seconds may restart the tracking process while a loss longer than 1 second may restart the acquisition and tracking processes.

It is appreciated that processes 800A and 800B may be assigned arbitrarily to two communication systems maintaining a communication link. In addition, processes 800A and 800B may include the assignment of one or more roles to each communication system. In one embodiment, a first communication system is assigned a chaser role and performs act 804 while a second communication is assigned a leader role and performs act 806. In this embodiment, the chaser and leader roles are reversed after a period of time. The chaser role, for example, may be first assigned to the northernmost communication system while the leader role may be first assigned to the southernmost communication system.

An example tracking process radiation pattern 1100 is shown with reference FIG. 11 formed by a communication system executing a tracking process. The tracking process radiation pattern 1100 includes the radiation pattern formed by the chaser antenna before a tracking correction, the chaser antenna radiation pattern before the correction comprising a scan circle 1102, a scan center 1104, a pointing vector 1110, a received power buffer 1108, and received power strength 1106, and the chaser antenna radiation after the correction, the chaser antenna radiation pattern after the correction comprising a scan center 1114, a scan circle 1112, a main lobe 1116, and a pointing vector 1118.

The leader pointing vector, not shown in FIG. 11, maintains a constant direction while the chaser antenna tracks the maximum received power direction. The chaser directional antenna performs a fixed radius scan shown by the scan circle 1102, scan center 1104, and pointing vectors 1110 before the correction. The received power strength 1106 is stored in a received power buffer 1108. The received power strength may be analyzed to steer the directive antenna in the direction of maximum power to move the center of the scan radius to the direction of maximum received power.

As shown in FIG. 11, the received power strength 1106 is substantially unequal over the scan circle 1102 before the correction. The received signal power at pointing vector 1110A is substantially higher than the received signal power at pointing vector 1110B before the correction. In response to the detected abnormality, the scan center is moved towards pointing vector 1110A in the direction of maximum power. The scan center moves from scan center 1104 before the correction to scan center 1114 after the correction. The movement of the scan center reduces the difference between the peaks in the received power strength. This indicates that the chaser antenna was successfully steered closer to the maximum power direction.

It is appreciated that the chaser directional antenna described above with reference to FIG. 11 may switch roles with the leader antenna and continue execution of the tracking processes 800A-B described with reference to FIGS. 8A-B.

In various embodiments, the various communication systems participating in the network employ the PAT process 500 to align two or more directional antennas and thereby create a communication link between two or more mobile vehicle. For example, in one embodiment, the mobile vehicles are UAVs that contain flight parameters (e.g., flight plans) that may be altered to improve or establish communication links within the network. Accordingly, in some embodiments the specific location of the mobile vehicles are configurable. In these embodiments, one or more state based adhoc networking processes may be implemented to optimize the location of the mobile vehicles for the establishment of critical communication links within an adhoc network.

### State Based AdHoc Networking

The communication system described herein may be employed on a plurality of mobile vehicles. These mobile vehicles may be connected together in an adhoc network through a plurality of communication links as shown in self aligning high data rate communication network 100 with reference to FIG. 1. FIG. 12 shows an example state based adhoc networking process 1200. The state based adhoc networking process includes act of identifying a current topology 1202, computing a desired topology 1204, and adjusting the topology 1206.

In act 1202, the current topology is identified. The current topology may be determined based upon state information (e.g., location, heading, and speed) aggregated from the mobile vehicles participating in the adhoc network. In addition, information regarding the status of each communication link in the adhoc network may be utilized to identify the current topology. Communication link status information may include, but is not limited to, a bit error rate (BER), a data rate, and a priority associated with the data.

In act 1204, a desired topology is identified. In one embodiment, the desired topology is identified consistent with a cost function. In this embodiment, the cost function is controlled at least in part by a coverage factor, a data rate factor, and a data priority factor. The desired topology is computed that minimizes the cost function. It is appreciated that a converse of the cost function (e.g., a value function) may be computed and maximized to determine the desired topology.

In act 1206, the topology of the mobile vehicles is adjusted to achieve the desired topology. In one embodiment, the mobile vehicles are UAVs and a new flight plan is determined for each UAV in the adhoc network to achieve the desired topology. The new flight plans are then transmitted to each UAV respectively. It is appreciated that the new flight plans may be computed at a base station and transmitted to the UAVs or alternatively calculated by one or more communication systems associated with UAVs within the adhoc network. The base station may include, for example, a ground station and/or an UAV designated to manage the network.

Having now described some illustrative aspects of the invention, it should be apparent to those skilled in the art that the foregoing is merely illustrative and not limiting, having been presented by way of example only. Numerous modifications and other illustrative embodiments are within the scope of one of ordinary skill in the art and are contemplated as falling within the scope of the invention.

Any embodiment disclosed herein may be combined with any other embodiment, and references to “an embodiment,” “some embodiments,” “an alternate embodiment,” “various embodiments,” “one embodiment,” “at least one embodiment,” “this and other embodiments” or the like are not necessarily mutually exclusive and are intended to indicate that a particular feature, structure, or characteristic described in connection with the embodiment may be included in at least one embodiment. Such terms as used herein are not necessarily all referring to the same embodiment. Any embodiment may be combined with any other embodiment in any manner consistent with the aspects disclosed herein. References to “or” may be construed as inclusive so that any terms described using “or” may indicate any of a single, more than one, and all of the described terms. Furthermore, it will be appreciated that the systems and methods disclosed herein are not limited to any particular application or field, but will be applicable to any endeavor wherein a value is apportioned among several placements.

Where technical features in the drawings, detailed description, or any claim are followed by references signs, the reference signs have been included for the sole purpose of increasing the intelligibility of the drawings, detailed description, and claims. Accordingly, neither the reference signs nor their absence are intended to have any limiting effect on the scope of any claim placements.

1. A communication system comprising:
at least one directional antenna;
an antenna steering system constructed to steer the at least one directional antenna;
a memory; and
one or more processors coupled to the memory, the at least one directional antenna, and the antenna steering system, the one or more processors configured to:
identify a communication target and state information associated with the communication target;
instruct the antenna steering system to steer the at least one directional antenna towards the communication target based on the state information;
instruct the antenna steering system to perform a received power scan within a scan area via the at least one directional antenna to determine a maximum received power direction associated with a signal transmitted from the communication target; and
instruct the antenna steering system to track the maximum received power direction.

2. The communication system according to claim 1, wherein the communication system further comprises at least one omnidirectional antenna and the one or more processors are configured to identify the communication target and the state information associated with the communication target at least in part by receiving the state information from the communication target via the at least one omnidirectional antenna.

3. The communication system according to claim 1, wherein the state information associated with the communication target includes at least one of a location, a heading, and a speed associated with the communication target.

4. The communication system according to claim 1, wherein the communication system is coupled to a host vehicle and the one or more processors are further configured to compensate a current direction of the at least one directional antenna for attitude changes of the host vehicle.

5. The communication system according to claim 4, wherein the one or more processors are further configured to receive vehicle attitude information from at least one of an Attitude and Heading Reference System (AHRS) and an Inertial Navigation System (INS) coupled to the communication system and instruct the antenna steering system to adjust the current direction of the at least one directional antenna based on the received vehicle attitude information.

6. The communication system according to claim 1, wherein the one or more processors are further configured to transmit state information associated with the host vehicle to the communication target, wherein the communication target includes at least one directional antenna, an antenna steering system to steer the at least one directional antenna, a memory, and one or more processors coupled to the memory, the at least one directional antenna, and the antenna steering system, the one or more processors of the communication target configured to:
receive the state information associated with the communication system; and
instruct the antenna steering system of the communication target to steer the at least one directional antenna toward the communication system.

7. The communication system according to claim 1, wherein the one or more processors are further configured to perform the received power scan within the scan area by:
instructing the antenna steering system to steer the at least one directional antenna to form a scan circle;
determining a peak power point on the scan circle; and
instructing the antenna steering system to steer the at least one directional antenna to form a scan arc with an arc center at the peak power point.

8. The communication system according to claim 7, wherein the one or more processors are further configured to form the scan circle by steering the directional antenna at a 0.5 degree offset from the scan circle center.

9. The communication system according to claim 1, wherein the one or more processors are further configured to:
instruct the antenna steering system to steer the at least one directional antenna to cover the scan area within a first period of time;
instruct the antenna steering system to steer the at least one directional antenna to the maximum received power direction within the scan area; and
instruct the antenna steering system to maintain a previous maximum received power direction within the scan area of the at least one directional antenna for a second period of time.

10. The communication system according to claim 9, wherein the one or more processors are configured to instruct the antenna steering system to steer the at least one directional antenna to cover the scan area at least in part by instructing the antenna steering system to steer the at least one directional antenna in one of an outward spiral pattern, a circle pattern, an arc pattern, and an ellipse pattern.

11. The communication system according to claim 9, wherein the communication target includes at least one directional antenna, an antenna steering system to steer the at least one directional antenna, a memory, and one or more processors coupled to the memory, the at least one directional antenna, and the antenna steering system, the one or more processors of the communication target configured to:
instruct the antenna steering system to maintain a current direction of the at least one directional antenna of the communication target for the first period of time;
instruct the antenna steering system to steer the at least one directional antenna of the communication target to cover the scan area within the second period of time; and
instruct the antenna steering system to steer the at least one directional antenna of the communication target to the maximum received power direction within the scan area.

12. The communication system according to claim 11, wherein the scan area includes an area between 0 and 5 degrees from a current direction of the at least one directional antenna and the first period of time is up to 5 seconds.

13. The communication system according to claim 1, wherein the one or more processors are further configured to:
instruct the antenna steering system to steer the at least one direction antenna in a fixed radius scan around the maximum received power direction for a first period of time; and
instruct the antenna steering system to maintain a current direction of the at least one directional antenna for a second period of time.

14. The communication system according to claim 13, wherein the communication target includes at least one directional antenna, a memory, and one or more processors coupled to the memory and the at least one directional antenna and configured to:
instruct the antenna steering system of the communication target to maintain a current direction of the at least one directional antenna of the communication target for the first period of time; and
instruct the antenna steering system of the communication target to perform the fixed radius scan for the second period of time.

15. A method of high data rate communication between a communication system and a communication target, the method comprising:
identifying a communication target and state information associated with the communication target;
steering at least one directional antenna towards the communication target based on the state information;
performing a received power scan within a scan area to determine a maximum received power direction associated with a signal transmitted from the communication target; and
tracking the maximum received power direction.

16. The method according to claim 15, wherein performing the received power scan within the scan includes:
steering the at least one directional antenna to form a scan circle;
determining a peak power point on the scan circle; and
steering the at least one directional antenna to form a scan arc with an arc center at the peak power point.

17. The method according to claim 15, wherein performing the received power scan within the scan area includes:
steering the at least one directional antenna to cover the scan area; and
steering the at least one directional antenna to the maximum received power direction within the scan area.

18. The method according to claim 15, wherein tracking the maximum received power direction includes steering the at least one direction antenna in a fixed radius scan around the maximum received power direction.

19. A communication system comprising:
at least one directional antenna;
an antenna steering system constructed to steer the at least one directional antenna including:
an elevation motor support structure;
an azimuth motor configured to rotate the elevation motor support structure about a first axis;
an antenna support structure configured to hold the at least one directional antenna; and
an elevation motor configured to rotate the antenna support structure about a second axis, the second axis being perpendicular to the first axis;
a memory; and
one or more processors coupled to the memory, the at least one directional antenna, and the antenna steering system, the one or more processors configured to:
identify a communication target;
instruct the antenna steering system to steer the at least one directional antenna towards the communication target;
instruct the antenna steering system to perform a received power scan within a scan area to determine a maximum received power direction associated with a signal transmitted from the communication target; and
instruct the antenna steering system to track the maximum received power direction.

20. The antenna steering system of claim 19, wherein the at least one directional antenna includes a feed horn and a lens and wherein the antenna steering system further includes a beam steering system constructed to steer a radio frequency beam from the feed horn, the beam steering system including:
a wedge prism having a vertex angle and being disposed between the feed horn and the lens, the wedge prism being constructed to redirect the radio frequency beam at an offset angle relative to a central axis, the offset angle being positively correlated to the vertex angle of the wedge prism;
a wedge prism support structure constructed to support the wedge prism at the distance from the feed horn; and
a wedge prism motor constructed to rotate the wedge prism support structure about the central axis.
